(19) United States
(12) Patent Application Publication
(10) Pub. No.: US 2025/0013138 A1
(43) Pub. Date: Jan. 9, 2025

(54) LIGHT SOURCE DEVICE, PROJECTOR, CONTROL METHOD FOR LIGHT SOURCE DEVICE, AND PROGRAM

(71) Applicant: Sharp NEC Display Solutions, Ltd., Tokyo (JP)

(72) Inventor: Sota HIRAHARA, Tokyo (JP)

(21) Appl. No.: 18/888,427

(22) Filed: Sep. 18, 2024

Related U.S. Application Data
(63) Continuation of application No. PCT/JP2022/015205, filed on Mar. 28, 2022.

(51) Int. Cl. G03B 21/20

(52) U.S. Cl. CPC G03B 21/2013; G03B 21/204; G03B 21/2073

(57) ABSTRACT

A light source device includes a control unit. The control unit is configured to adjust a first drive current value of a first laser light source unit and a second drive current value of a second laser light source unit, on the basis of a first measurement result and a second measurement result. The first measurement result is acquired by a first sensor measuring a first light quantity of red light included in white light that is synthesized and emitted by the polarization separation element. The second measurement result is acquired by a second sensor measuring a second light quantity of blue light included in the white light.

### TECHNICAL FIELD

The present invention relates to a light source device, a projector, a control method for a light source device, and a program.

### BACKGROUND ART

Laser light sources such as a laser diode (LD) and the like are used in light source devices of projectors. In Patent Document 1, a projector (a projection-type display device) including laser light sources (a solid-state light source unit) is described. The projector described in Patent Document 1 includes a light source device (a solid-state light source unit) in which a plurality of laser light sources (semiconductor lasers) are arranged in a two-dimensional form. In the projector (a projection-type display device) described in Patent Document 1, laser light emitted from the light source device is incident on an optical modulation element (a light valve unit) of a liquid crystal display (LCD) or the like through an optical system (an illumination unit) such as a lens.

Among recent projectors, for the purpose of decreasing the size of a device, there is a projector that includes a light source device in which laser modules acquired by housing a plurality of LD chips in one package are arranged in an array form. In this projector, a laser beam emitted from each laser module is incident on an optical modulation element or a fluorescent member through an optical system. The optical system includes a reduction optical system used for reducing the diameter of a light beam to a predetermined size.

In order to acquire white light of a desired color tone, it is necessary to perform design such that the numbers of LD chips of a blue light source and an excitation light source satisfy a predetermined ratio.

In the light source device (a solid-state light source unit) described in Patent Document 1, by changing the arrangement (a position in an optical axis direction) and the rotation (a position in the rotation direction) of a phase difference plate (½ wavelength plate), a polarization ratio of a light source is adjusted to change the color tone.

The adjustment of the phase difference plate in the light source device as described above requires high adjustment accuracy, and thus an adjustment mechanism is expensive, and the size becomes large.

In Patent Document 2, a projector including a light source device is described. The light source device described in Patent Document 2 includes a first light source and a second light source emitting blue light of which polarization directions are different from each other by 90 degrees. In addition, the light source device described in Patent Document 2 includes a controller that controls amounts of light emission of the first light source and the second light source.

In Patent Document 2, in order to inhibit a change in a color tone of light emitted from the light source device in accordance with a change of the amount of light emission of one of the first light source and the second light source, it is described that a controller records a change of the color tone of light emitted from the light source device while changing amounts of light emission of the first light source and the second light source. However, in Patent Document 2, a specific configuration for recording the change of the color tone of light emitted from the light source device has not been described. For this reason, according to a technology described in Patent Document 2, the color tone of light emitted from a light source device cannot be appropriately adjusted.

In addition, in Patent Document 2, it is described that the controller acquires amounts of degradation of the first light source and the second light source and performs control of driving of the first light source and the second light source in accordance with amounts of changes in the amounts of light emission of the first light source and the second light source acquired from the amounts of degradation of the first light source and the second light source. However, even before the first light source and the second light source are degraded, there are also cases in which adjustment of the color tone of light emitted from the light source device is necessary. In such a case, according to the technology described in Patent Document 2, the color tone of light emitted from the light source device cannot be appropriately adjusted.

Furthermore, in Patent Document 2, it is described that the controller changes the amounts of light emission of the first light source and the second light source in accordance with the brightness of a light source set by a user in case that the user sets the brightness of the light source by performing a setting operation for the projector. However, in Patent Document 2, although it is described that, in case that a user sets the brightness of a light source, how the controller needs to change the amounts of light emission of the first light source and the second light source is acquired using a lookup table, actually, it cannot be determined that states of the first light source and the second light source at a time point at which the lookup table was generated and states of the first light source and the second light source at a time point at which the user sets the brightness of the light source are the same. For example, in case that the states of the first light source and the second light source at a time point at which the lookup table was generated and the states of the first light source and the second light source at a time point at which the user sets the brightness of the light source are different from each other, even when the amounts of light emission of the first light source and the second light source are changed on the basis of the lookup table, the color tone of light emitted from the light source device cannot be appropriately adjusted.

### CITATION LIST

### Patent Document

[Patent Document 1]
Japanese Unexamined Patent Application, First Publication No. 2012-137744
[Patent Document 2]
Japanese Unexamined Patent Application, First Publication No. 2020-173302

### SUMMARY OF INVENTION

### Technical Problem

In view of the points described above, an object of the present invention is to provide a light source device, a projector, a control method for a light source device, and a program capable of automatically adjusting the color tone of light emitted from a light source device appropriately.

### Solution to Problem

According to one aspect of the present invention, there is provided a light source device including: a first laser light source unit configured to emit first-color light having a first polarization direction; a second laser light source unit configured to emit first-color light having a second polarization direction different from the first polarization direction; a polarization separation element configured to separate the first-color light, which has the first polarization direction, emitted from the first laser light source unit and the first-color light, which has the second polarization direction, emitted from the second laser light source unit into a first light beam and a second light beam; a wavelength conversion element configured to convert the first light beam separated by the polarization separation element into a third light beam; an optical element configured to convert the second light beam separated by the polarization separation element into a fourth light beam; and a control unit configured to execute control of adjusting a drive current value of the first laser light source unit and a drive current value of the second laser light source unit, in which the polarization separation element has a function of synthesizing the third light beam converted by the wavelength conversion element and the fourth light beam converted by the optical element, and the control unit adjusts the drive current value of the first laser light source unit and the drive current value of the second laser light source unit on the basis of a measurement result acquired by a first sensor measuring a light quantity of red light included in white light that is synthesized and emitted by the polarization separation element and a measurement result acquired by a second sensor measuring a light quantity of blue light included in the white light.

According to one aspect of the present invention, there is provided a projector including: a light source device; an optical modulation unit configured to form an image by modulating emission light of the light source device; and a projection lens configured to project the image formed by the optical modulation unit.

A manufacturing method for a light source device according to one aspect of the present invention is a control method for a light source device including: a first laser light source unit configured to emit first-color light having a first polarization direction; a second laser light source unit configured to emit first-color light having a second polarization direction different from the first polarization direction; a polarization separation element configured to separate the first-color light, which has the first polarization direction, emitted from the first laser light source unit and the first-color light, which has the second polarization direction, emitted from the second laser light source unit into a first light beam and a second light beam; a wavelength conversion element configured to convert the first light beam separated by the polarization separation element into a third light beam; and an optical element configured to convert the second light beam separated by the polarization separation element into a fourth light beam, in which the polarization separation element has a function of synthesizing the third light beam converted by the wavelength conversion element and the fourth light beam converted by the optical element, the control method including: a measurement result acquiring step of acquiring a measurement result acquired by a first sensor measuring a light quantity of red light included in white light that is synthesized and emitted by the polarization separation element and a measurement result acquired by a second sensor measuring a light quantity of blue light included in the white light; and an adjustment step of adjusting the drive current value of the first laser light source unit and the drive current value of the second laser light source unit on the basis of a measurement result acquired by the first sensor and a measurement result acquired by the second sensor in the measurement result acquiring step.

A program according to one aspect of the present invention is a program causing a computer configuring a control unit included in a light source device including: a first laser light source unit configured to emit first-color light having a first polarization direction; a second laser light source unit configured to emit first-color light having a second polarization direction different from the first polarization direction; a polarization separation element configured to separate the first-color light, which has the first polarization direction, emitted from the first laser light source unit and the first-color light, which has the second polarization direction, emitted from the second laser light source unit into a first light beam and a second light beam; a wavelength conversion element configured to convert the first light beam separated by the polarization separation element into a third light beam, and an optical element configured to convert the second light beam separated by the polarization separation element into a fourth light beam, to execute: a measurement result acquiring step of acquiring a measurement result acquired by a first sensor measuring a light quantity of red light included in white light that is synthesized and emitted by the polarization separation element and a measurement result acquired by a second sensor measuring a light quantity of blue light included in the white light; and an adjustment step of adjusting the drive current value of the first laser light source unit and the drive current value of the second laser light source unit on the basis of a measurement result acquired by the first sensor and a measurement result acquired by the second sensor in the measurement result acquiring step, in which the polarization separation element has a function of synthesizing the third light beam converted by the wavelength conversion element and the fourth light beam converted by the optical element.

### Advantageous Effects of Invention

According to the present invention, the color tone of light emitted from a light source device can be automatically adjusted appropriately.

### BRIEF DESCRIPTION OF DRAWINGS

FIG. 1 is a diagram illustrating one example of a light source device 90 according to a first embodiment.

FIG. 2 is a diagram for describing one example of characteristics of a polarization separation element 4.

FIG. 3 is a diagram illustrating one example of a projector PJ including the light source device 90 according to the first embodiment.

FIG. 4 is a flowchart for describing one example of an adjustment process for drive current values of laser light source units 1A, 1B, and 1C that is performed by a control unit 10 of the light source device 90 according to the first embodiment.

FIG. 5 is a diagram illustrating one example of a light source device 90 according to a second embodiment.

### DESCRIPTION OF EMBODIMENTS

Hereinafter, a light source device, a projector, a control method for a light source device, and a program according to embodiments of the present invention will be described with reference to the drawings.

### First Embodiment

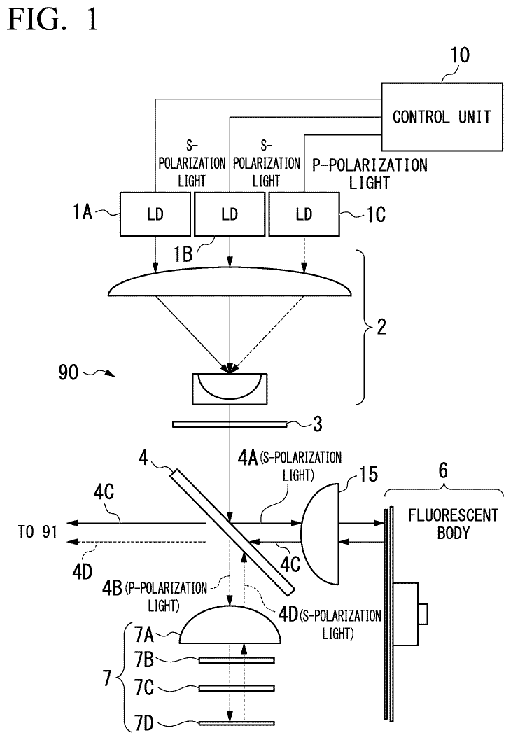

FIG. 1 is a diagram illustrating one example of a light source device 90 according to a first embodiment.

In the example illustrated in FIG. 1, the light source device 90 includes a laser light source unit 1A, a laser light source unit 1B, a laser light source unit 1C, a reduction optical system 2, a diffusion element 3, a polarization separation element 4, a condensing optical system 15, a wavelength conversion element 6, an optical element 7, and a control unit 10.

The laser light source unit 1A, for example, emits first-color light such as blue light. The laser light emitted from the laser light source unit 1A, for example, is S-polarization light and has a first polarization direction. Similar to the laser light source unit 1A, the laser light source unit 1B emits first-color light, for example, such as blue light. Similar to the laser light emitted from the laser light source unit 1A, the laser light emitted from the laser light source unit 1B, for example, is S-polarization light and has the first polarization direction. Similar to the laser light source units 1A and 1B, the laser light source unit 1C emits first-color light, for example, such as blue light. The laser light emitted from the laser light source unit 1C, for example, is P-polarization light and has a second polarization direction different from the first polarization direction.

In the example illustrated in FIG. 1, although the laser light source unit 1A emits blue light as the first-color light, in another example, the laser light source unit 1A, for example, may emit light of a color other than blue such as green light as the first color.

In the example illustrated in FIG. 1, the reduction optical system 2 reduces laser beams emitted from the laser light source units 1A, 1B, and 1C into one laser beam (in other words, reduces the diameter). The diffusion element 3, for example, is configured using a diffusion plate. The diffusion element 3 diffuses the laser beam of which the diameter has been reduced by the reduction optical system 2.

The polarization separation element 4, for example, is configured using a dichroic mirror (DM).

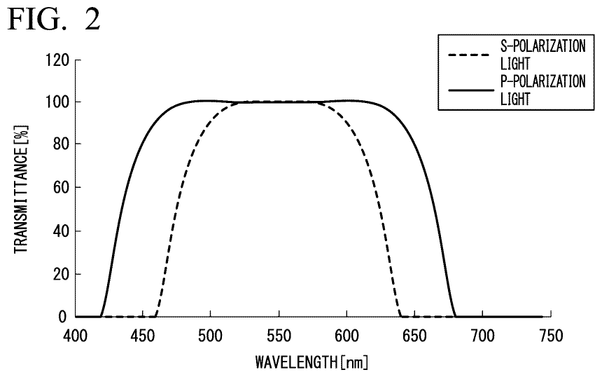

FIG. 2 is a diagram for describing one example of characteristics of the polarization separation element 4. In FIG. 2, a horizontal axis represents a wavelength [nm] of light incident on the polarization separation element 4, and a vertical axis represents transmittance [%] of light incident on the polarization separation element 4. In addition, in FIG. 2, a broken line represents a relation between a wavelength and transmittance of S-polarization light incident on the polarization separation element 4, and a solid line represents a relation between a wavelength and transmittance of P-polarization light incident on the polarization separation element 4.

In the examples illustrated in FIGS. 1 and 2, the wavelength of S-polarization light that is emitted from the laser light source units 1A and 1B is set such that S-polarization light that is emitted from the laser light source units 1A and 1B and is incident on the polarization separation element 4 is not transmitted through the polarization separation element 4 (it is reflected by the polarization separation element 4). In addition, the wavelength of P-polarization light that is emitted from the laser light source unit 1C is set such that P-polarization light that is emitted from the laser light source unit 1C and is incident on the polarization separation element 4 is transmitted through the polarization separation element 4.

In other words, in the examples illustrated in FIGS. 1 and 2, first-color light (S-polarization light), which has a first polarization direction, emitted from the laser light source units 1A and 1B is reflected by the polarization separation element 4. First-color light (P-polarization light), which has a second polarization direction, emitted from the laser light source unit 1C is transmitted through the polarization separation element 4. In other words, the polarization separation element 4 separates the first-color light, which has the first polarization direction, emitted from the laser light source units 1A and 1B and the first-color light, which has the second polarization direction, emitted from the laser light source unit 1C into a light beam 4A (light reflected by the polarization separation element 4) and a light beam 4B (light transmitted through the polarization separation element 4).

The condensing optical system 15 reduces a light beam diameter of the light beam 4A. The light beam 4A of which the light beam diameter has been reduced by the condensing optical system 15 is emitted to the wavelength conversion element 6.

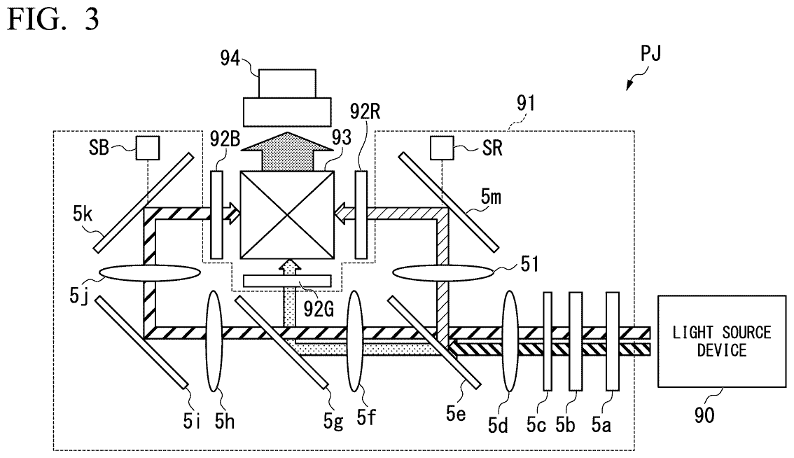

The wavelength conversion element 6 includes a fluorescent body that is configured to be rotatable. The wavelength conversion element 6 receives the light beam 4A emitted from the condensing optical system 15 and emits yellow fluorescent light (a light beam 4C) to the condensing optical system 15 side. In other words, the wavelength conversion element 6 has a function of converting the light beam 4A separated by the polarization separation element 4 into the light beam 4C. The light beam 4C (the yellow fluorescent light) emitted from the wavelength conversion element 6 is converted into pseudo-parallel light by the condensing optical system 15, is transmitted through the polarization separation element 4 (the dichroic mirror), and is emitted to an illumination optical system 91 (see FIG. 3).

In the example illustrated in FIG. 1, although the wavelength conversion element 6 emits yellow light to the condensing optical system 15 side, in another example, the wavelength conversion element 6 may emit green light to the condensing optical system 15 side, or the wavelength conversion element 6 may emit light of a plurality of colors to the condensing optical system 15 side.

The first-color light (P-polarization light) (the light beam 4B), which has the second polarization direction, emitted from the laser light source unit 1C and transmitted through the polarization separation element 4 is incident on the optical element 7. The optical element 7 includes a condensing optical system 7A, a phase difference plate 7B, a diffusion element 7C, and a reflective element 7D.

The condensing optical system 7A reduces the light beam diameter of the light beam 4B. The light beam 4B (P-polarization light) of which the light beam diameter has been reduced by the condensing optical system 7A is incident on the phase difference plate 7B. The phase difference plate 7B converts a polarization direction of the incident light beam 4B. The light that has been transmitted through the phase difference plate 7B is incident on the diffusion element 7C. The diffusion element 7C includes a diffusion plate. The diffusion plate causes the incident light to diffuse. The light that has been transmitted through the diffusion element 7C is incident on the reflective element 7D. The reflective element 7D includes a mirror. Light reflected by the mirror is transmitted through the diffusion element 7C and is incident on the phase difference plate 7B. In accordance with the phase difference plate 7B converting the polarization direction of the incident light, S-polarization light (a light beam 4D) is emitted from the phase difference plate 7B. The light beam 4D (S-polarization light) emitted from the phase difference plate 7B is transmitted through the condensing optical system 7A and is incident on the polarization separation element 4.

In other words, the optical element 7 has a function of converting the light beam 4B that is separated by the polarization separation element 4 and is incident on the optical element 7 into the light beam 4D.

The light beam 4D (S-polarization light) that is transmitted through the condensing optical system 7A and is incident on the polarization separation element 4 is reflected by the polarization separation element 4 and is emitted to the illumination optical system 91 (see FIG. 3).

In other words, the polarization separation element 4 has a function of synthesizing the light beam 4C converted by the wavelength conversion element 6 and the light beam 4D converted by the optical element 7.

The control unit 10 executes control of adjustment of a drive current value of the laser light source unit 1A, a drive current value of the laser light source unit 1B, and a drive current value of the laser light source unit 1C.

In the example illustrated in FIG. 1, although the light source device 90 includes three laser light source units 1A, 1B, and 1C, in another example, the light source device 90 may include a plurality of laser light source units other than three laser light source units.

In further another example, switching between an optical path of the wavelength conversion element 6 illustrated in FIG. 1 and an optical path of the optical element 7 may be performed.

FIG. 3 is a diagram illustrating one example of a projector PJ including the light source device 90 according to the first embodiment.

In the example illustrated in FIG. 3, the projector PJ according to the first embodiment includes a light source device 90, an illumination optical system 91, optical modulation units 92R, 92G, and 92B, a cross-dichroic prism 93, and a projection lens 94.

The illumination optical system 91 separates white light emitted by the light source device 90 into red light for illuminating the optical modulation unit 92R, green light for illuminating the optical modulation unit 92G, and blue light for illuminating the optical modulation unit 92B. Each of the optical modulation units 92R, 92G, and 92B includes a liquid crystal panel that forms an image by modulating light. The optical modulation unit 92R forms a red image, the optical modulation unit 92G forms a green image, and the optical modulation unit 92B forms a blue image.

The illumination optical system 91 includes fly-eye lenses 5a and 5b, a polarization conversion element 5c, a superimposed lens 5d, dichroic mirrors 5e and 5g, field lenses 5f and 5l, relay lenses 5h and 5j, mirrors 5i, 5k, and 5m, and sensors SR and SB. The white light emitted by the light source device 90 is incident on the dichroic mirror 5e through the fly-eye lenses 5a and 5b, the polarization conversion element 5c, and the superimposed lens 5d.

The fly-eye lenses 5a and 5b are disposed to face each other. Each of the fly-eye lenses 5a and 5b includes a plurality of microlenses. The microlenses of the fly-eye lens 5a respectively face the microlenses of the fly-eye lens 5b. In the fly-eye lens 5a, emitted light of the light source device 90 is divided into a plurality of light beams corresponding to the number of microlenses. Each microlens forms a shape similar to an effective display area of a liquid crystal panel and condenses a light beam from the light source device 90 to an area near the fly-eye lens 5b.

The superimposed lens 5d and a field lens 5l cause a main light ray from each microlens of the fly-eye lens 5a to be directed toward a center part of the liquid crystal panel of the optical modulation unit 92R and superimposes the image of each microlens on the liquid crystal panel. Similarly, the superimposed lens 5d and a field lens 5f cause a main light ray from each microlens of the fly-eye lens 5a to be directed toward a center part of the liquid crystal panel of each of the optical modulation units 92G and 92B and superimposes the image of each microlens on the liquid crystal panel.

The polarization conversion element 5c aligns a polarization direction of light that has been transmitted through fly-eye lenses 5a and 5b as P-polarization light or S-polarization light. The dichroic mirror 5e has characteristics in which light of a red wavelength region out of visible light is reflected, and light of the other wavelength regions is transmitted.

Light (red light) reflected by the dichroic mirror 5e is emitted to the liquid crystal panel of the optical modulation unit 92R through the field lens 5l and a mirror 5m. In other words, the mirror 5m is disposed on an optical path of red light emitted to the liquid crystal panel of the optical modulation unit 92R. A sensor SR is disposed on an extension line of the optical path of red light incident on the mirror 5m. The sensor SR measures a light quantity of red light that has been transmitted through the mirror 5m without being reflected by the mirror 5m. In other words, the sensor SR measures a light quantity of red light included in white light that is synthesized by the polarization separation element 4 of the light source device 90 and is emitted to the illumination optical system 91.

On the other hand, light (blue light and green light) that has been transmitted through the dichroic mirror 5e is incident on the dichroic mirror 5g through the field lens 5f. The dichroic mirror 5g has a characteristic in which light of a green wavelength region out of visible light is reflected, and light of the other wavelengths is transmitted.

Light (green light) reflected by the dichroic mirror 5g is emitted to the liquid crystal panel of the optical modulation unit 92G.

On the other hand, light (blue light) that has been transmitted through the dichroic mirror 5g is emitted to the liquid crystal panel of the optical modulation unit 92B through a relay lens 5h, a mirror 5i, a relay lens 5j, and a mirror 5k. In other words, the mirror 5k is disposed on an optical path of blue light emitted to the liquid crystal panel of the optical modulation unit 92B. The sensor SB is disposed on an extension line of the optical path of blue light incident on the mirror 5k. The sensor SB measures a light quantity of blue light transmitted through the mirror 5k without being reflected by the mirror 5k. In other words, the sensor SB measures a light quantity of blue light included in white light that is synthesized by the polarization separation element 4 of the light source device 90 and is emitted to the illumination optical system 91.

The cross-dichroic prism 93 has first to third incidence faces and an emission face. In the cross-dichroic prism 93, red image light is incident on the first incidence face, green image light is incident on the second incidence face, and blue image light is incident on the third incidence face. The red image light, the green image light, and the blue image light are emitted from the emission face in the same optical path.

The red image light, the green image light, and the blue image light emitted from the emission face of the cross-dichroic prism 93 are incident on the projection lens 94. The projection lens 94 projects a red image, a green image, and a blue image onto a screen in an overlapping manner. In other words, the projection lens 94 projects the red image formed by the optical modulation unit 92R, the green image formed by the optical modulation unit 92G, and the blue image formed by the optical modulation unit 92B onto the screen.

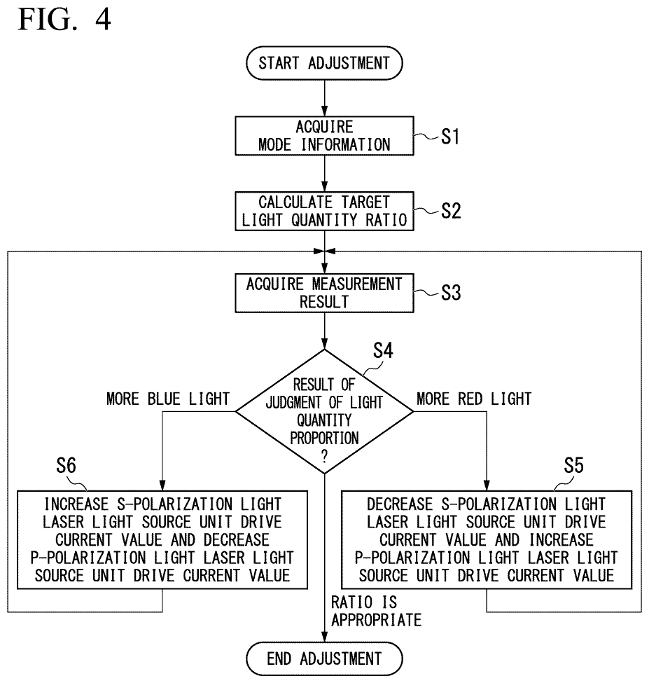

FIG. 4 is a flowchart for describing one example of an adjustment process for drive current values of the laser light source units 1A, 1B, and 1C that is performed by the control unit 10 of the light source device 90 according to the first embodiment.

In the example illustrated in FIG. 4, when adjustment of the drive current values of the laser light source units 1A, 1B, and 1C using the control unit 10 starts, in Step S1, the control unit 10 acquires information representing a mode set by a user of the projector PJ. The reason for this is that a target light quantity ratio that is a ratio between a light quantity of red light to be measured by the sensor SR and a light quantity of blue light to be measured by the sensor SB differs in accordance with the mode set by the user of the projector PJ.

Next, in Step S2, the control unit 10 calculates the target light quantity ratio on the basis of information representing the mode acquired in Step S1. The stronger red light of the mode set by the user of the projector PJ, the larger the value of the target light quantity ratio calculated in Step S2. In other words, the stronger the blue tone of a mode set by the user of the projector PJ, the smaller the value of the target light quantity ratio calculated in Step S2.

Next, in Step S3, the control unit 10 acquires information representing a light quantity of red light that has been measured by the sensor SR and information representing a light quantity of blue light that has been measured by the sensor SB. In addition, the control unit 10 calculates an actual light quantity ratio that is a ratio between the light quantity of red light that has been measured by the sensor SR and the light quantity of blue light that has been measured by the sensor SB. In other words, in Step S3, the control unit 10 acquires the measurement result acquired by the sensor SR and the measurement result acquired by the sensor SB.

Next, in Step S4, the control unit 10 performs judgment of a proportion of light quantities. In more detail, in Step S4, the control unit 10 compares the actual light quantity ratio calculated in Step S3 with the target light quantity ratio calculated in Step S2.

In case that the actual light quantity ratio is higher than the target light quantity ratio, in other words, there is more red light (in case that red light of white light on the screen is stronger than that of the mode set by the user of the projector PJ), the process proceeds to Step S5.

In Step S5, the control unit 10 decreases drive current values of the laser light source units 1A and 1B emitting the first-color light (S-polarization light) having the first polarization direction and increases a drive current value of the laser light source unit 1C emitting the first-color light (P-polarization light) having the second polarization direction.

Next, the process returns to Step S3.

In case that the actual light quantity ratio is lower than the target light quantity ratio, in other words, there is more blue light (in case that the blue tone of white light on the screen is stronger than that of the mode set by the user of the projector PJ), the process proceeds to Step S6.

In Step S6, the control unit 10 increases the drive current values of the laser light source units 1A and 1B emitting the first-color light (S-polarization light) having the first polarization direction and decreases the drive current value of the laser light source unit 1C emitting the first-color light (P-polarization light) having the second polarization direction.

Next, the process returns to Step S3.

In case that the actual light quantity ratio is the same as the target light quantity ratio, in other words, in case that a ratio between the light quantity of red light and the light quantity of blue light is appropriate, the adjustment of the drive current values of the laser light source units 1A, 1B, and 1C that is performed by the control unit 10 ends.

In other words, in the example illustrated in FIG. 4, on the basis of a measurement result acquired by the sensor SR measuring a light quantity of red light included in white light that is synthesized by the polarization separation element 4 of the light source device 90 and is emitted to the illumination optical system 91 and a measurement result acquired by the sensor SB measuring a light quantity of blue light included in the white light, the control unit 10 adjusts the drive current values of the laser light source units 1A and 1B and the drive current value of the laser light source unit 1C in Steps S5 and S6.

For this reason, in the example illustrated in FIG. 4, the color tone of light emitted from the light source device 90 to the illumination optical system 91 can be appropriately adjusted automatically (in other words, a user of the projector PJ does not need to determine whether the drive current values of the laser light source units 1A, 1B, and 1C are to be increased or decreased).

### Second Embodiment

Hereinafter, a light source device, a projector, a control method for a light source device, and a program according to a second embodiment of the present invention will be described.

The projector PJ according to the second embodiment is configured to be similar to the projector PJ according to the first embodiment described above except for points to be described below. Thus, according to the projector PJ of the second embodiment, effects similar to those of the projector PJ according to the first embodiment described above can be acquired except for the points to be described below.

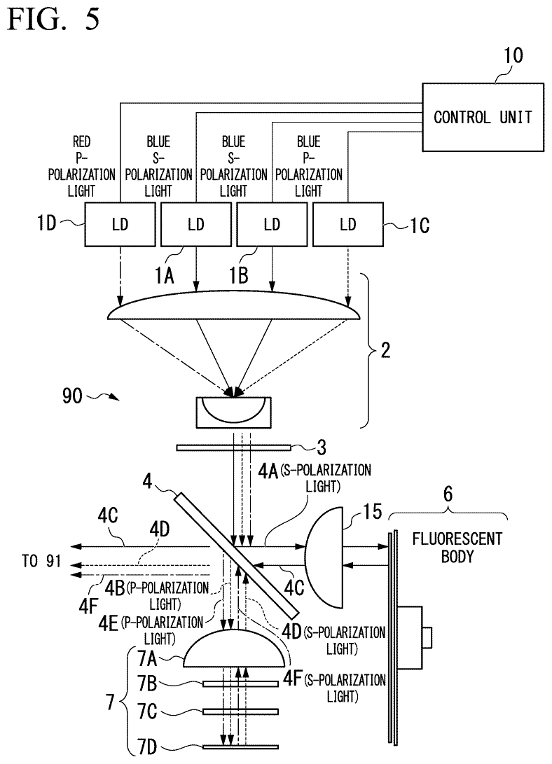

FIG. 5 is a diagram illustrating one example of the light source device 90 according to the second embodiment.

In the example illustrated in FIG. 5, the light source device 90 includes a laser light source unit 1A, a laser light source unit 1B, a laser light source unit 1C, a laser light source unit 1D, a reduction optical system 2, a diffusion element 3, a polarization separation element 4, a condensing optical system 15, a wavelength conversion element 6, an optical element 7, and a control unit 10.

Different from the laser light source units 1A, 1B, and 1C, the laser light source unit 1D emits second-color light (in other words, second-color light of which a wavelength is different from that of first-color light), for example, red light. Laser light emitted from the laser light source unit 1D, for example, is P-polarization light and has a second polarization direction different from a first polarization direction.

In the example illustrated in FIG. 5, although the laser light source unit 1D emits red light as the second-color light, in another example, the laser light source unit 1D may emit light of a color other than red, for example, green light or the like as the second-color light.

In the example illustrated in FIG. 5, the reduction optical system 2 reduces laser beams emitted from the laser light source units 1A, 1B, and 1C into one laser beam (in other words, the diameter is reduced).

In the example illustrated in FIG. 5, the wavelength of S-polarization light that is emitted from the laser light source units 1A and 1B is set such that S-polarization light that is emitted from the laser light source units 1A and 1B and is incident on the polarization separation element 4 is not transmitted through the polarization separation element 4 (it is reflected by the polarization separation element 4). In addition, the wavelength of P-polarization light that is emitted from the laser light source units 1C and 1D is set such that P-polarization light that is emitted from the laser light source units 1C and 1D and is incident on the polarization separation element 4 is transmitted through the polarization separation element 4.

In other words, in the example illustrated in FIG. 5, first-color light (S-polarization light), which has a first polarization direction, emitted from the laser light source units 1A and 1B is reflected by the polarization separation element 4. First-color light (P-polarization light), which has a second polarization direction, emitted from the laser light source unit 1C and second-color light (P-polarization light), which has a second polarization direction, emitted from the laser light source unit 1D are transmitted through the polarization separation element 4. In other words, the polarization separation element 4 separates the first-color light, which has the first polarization direction, emitted from the laser light source units 1A and 1B, the first-color light, which has the second polarization direction, emitted from the laser light source unit 1C, and the second-color light, which has the second polarization direction, emitted from the laser light source unit 1D into a light beam 4A (light that is emitted from the laser light source units 1A and 1B and is reflected by the polarization separation element 4), a light beam 4B (light emitted from the laser light source unit 1C and is transmitted through the polarization separation element 4), and a light beam 4E (light emitted from the laser light source unit 1D and is transmitted through the polarization separation element 4).

In the example illustrated in FIG. 5, although the wavelength conversion element 6 emits yellow light to the condensing optical system 15 side, in another example, the wavelength conversion element 6 may emit green light to the condensing optical system 15 side, or the wavelength conversion element 6 may emit light of a plurality of colors to the condensing optical system 15 side.

In the example illustrated in FIG. 5, the first-color light (P-polarization light) (the light beam 4B), which has the second polarization direction, emitted from the laser light source unit 1C and transmitted through the polarization separation element 4 and the second-color light (P-polarization light) (the light beam 4E), which has the second polarization direction, transmitted through the polarization separation element 4 are incident on the optical element 7.

The condensing optical system 7A reduces the light beam diameters of the light beam 4B and the light beam 4E. The light beam 4B (P-polarization light) and the light beam 4E (P-polarization light) of which the light beam diameters have been reduced by the condensing optical system 7A are incident on the phase difference plate 7B. The phase difference plate 7B converts polarization directions of the light beam 4B and the light beam 4E that have been incident. The light that has been transmitted through the phase difference plate 7B is incident on the diffusion element 7C. The light that has been transmitted through the diffusion element 7C is incident on the reflective element 7D. Light reflected by the reflective element 7D is transmitted through the diffusion element 7C and is incident on the phase difference plate 7B. In accordance with the phase difference plate 7B converting the polarization directions of the incident light (in more detail, the light beam 4B is converted into a light beam 4D, and the light beam 4E is converted into a light beam 4F), S-polarization light (the light beam 4D) and S-polarization light (the light beam 4F) are emitted from the phase difference plate 7B. The light beam 4D (S-polarization light) and the S-polarization light (the light beam 4F) emitted from the phase difference plate 7B are transmitted through the condensing optical system 7A and are incident on the polarization separation element 4.

In other words, the optical element 7 has a function of converting the light beam 4B that is separated by the polarization separation element 4 and is incident on the optical element 7 into the light beam 4D and converting the light beam 4E that is separated by the polarization separation element 4 and is incident on the optical element 7 into the light beam 4F.

The light beam 4D (S-polarization light) and the light beam 4F (S-polarization light) that are transmitted through the condensing optical system 7A and are incident on the polarization separation element 4 are reflected by the polarization separation element 4 and are emitted to the illumination optical system 91 (see FIG. 3).

In other words, the polarization separation element 4 has a function of synthesizing the light beam 4C converted by the wavelength conversion element 6 and the light beams 4D and 4F converted by the optical element 7.

The control unit 10 executes control of adjustment of a drive current value of the laser light source unit 1A, a drive current value of the laser light source unit 1B, and a drive current value of the laser light source unit 1C.

In another example, the control unit 10 may execute control of adjustment of a drive current value of the laser light source unit 1A, a drive current value of the laser light source unit 1B, a drive current value of the laser light source unit 1C, and a drive current value of the laser light source unit 1D.

In the configuration described in Patent Document 1, when a light source of a wavelength different from that of a blue color such as a red color is used, a part is separated by the polarization separation element, is incident on the wavelength conversion element, and is converted into heat.

In contrast to this, in the light source device 90 according to the second embodiment, a polarization direction of red light, which has been emitted from the laser light source unit 1D, incident on the polarization separation element 4 is aligned with a polarization direction of blue light, which has been emitted from the laser light source unit 1C, incident on the polarization separation element 4, and thus there is no light that is separated as in the configuration described in Patent Document 1 (in other words, there is no part of red light, which has been emitted from the laser light source unit 1D, incident on the wavelength conversion element 6). For this reason, in the light source device 90 according to the second embodiment, as in the example illustrated in FIG. 5, the laser light source unit 1D emitting light of which a wavelength is different from that of light emitted from the laser light source units 1A, 1B, and 1C can be used without degrading the light use efficiency.

A projector PJ including the light source device 90 according to the second embodiment is configured to be similar to the projector PJ illustrated in FIG. 3.

In the control unit 10 of the light source device 90 according to the second embodiment, similar to the example illustrated in FIG. 4, an adjustment process of drive current values of the laser light source units 1A, 1B, and 1C is executed.

As described above, in another example, in a step corresponding to Step S5 represented in FIG. 4, the control unit 10 may increase the drive current value of the laser light source unit 1C emitting the first-color light (P-polarization light) having the second polarization direction and decrease the drive current value of the laser light source unit 1D emitting the second-color light (P-polarization light) having the second polarization direction.

In addition, in a step corresponding to Step S6 represented in FIG. 4, the control unit 10 may decrease the drive current value of the laser light source unit 1C emitting the first-color light (P-polarization light) having the second polarization direction and decrease the drive current value of the laser light source unit 1D emitting the second-color light (P-polarization light) having the second polarization direction.

In another example of the projector PJ according to the first or second embodiment described above, green fluorescent light is emitted from the wavelength conversion element 6 as the light beam 4C.

In this example, a third sensor (not illustrated) measuring a light quantity of green light included in white light that is synthesized and emitted by the polarization separation element 4 may be included in the illumination optical system 91.

A green color has a significant influence on the brightness and thus cannot be changed much, and thus, when color adjustment is performed, basically, a light quantity ratio between a red color and a blue color is adjusted. A target value of the light quantity of the green color to be measured by the third sensor in a mode set by a user is determined, and the third sensor measures the light quantity of green light included in white light that is synthesized and emitted by the polarization separation element 4.

In another example, without using the third sensor, regardless of the light quantity of green light included in white light that is synthesized and emitted by the polarization separation element 4, the drive current values of the laser light source units 1A to 1D may be adjusted on the basis of measurement results acquired by the sensors SR and SB. In other words, in this example, if the measurement results acquired by the sensors SR and SB do not change, although the light quantity of green light included in white light that is synthesized and emitted by the polarization separation element 4 is changed, the drive current values of the laser light source units 1A to 1D become current values determined in advance.

As above, although the form for performing the present invention has been described using the embodiment, the present invention is not limited to such embodiment at all, and various modifications and substitutions can be added within a range not departing from the concept of the present invention. The configurations described in each embodiment and each example described above may be combined as is appropriate.

In addition, the entire function of each unit included in the control unit 10 according to the embodiment described above or a part thereof may be realized by recording a program for realizing such a function on a computer-readable recording medium and causing a computer system to read and execute the program recorded on this recording medium. In addition, a “computer system” described here includes an OS and hardware such as peripherals.

In addition, the “computer-readable recording medium” represents a portable medium such as a flexible disc, a magneto-optical disk, a ROM, or a CD-ROM or a storage unit such as a hard disk built into a computer system. Furthermore, the “computer-readable recording medium” may include a medium dynamically storing the program for a short time such as a communication line of a case in which the program is transmitted through a network such as the Internet or a communication circuit line such as a telephone line and a medium storing the program for a predetermined time such as an internal volatile memory of the computer system that becomes a server or a client in such a case. In addition, the program described above may be a program used for realizing a part of the function described above or a program that can realize the function described above in combination with a program that is already recorded in the computer system.

### REFERENCE SIGNS LIST

90 Light source device
1A Laser light source unit
1B Laser light source unit
1C Laser light source unit
1D Laser light source unit
2 Reduction optical system
3 Diffusion element
4 Polarization separation element
4A, 4B, 4C, 4D, 4E, 4F Light beam
15 Condensing optical system
6 Wavelength conversion element
7 Optical element
7A Condensing optical system
7B Phase difference plate
7C Diffusion element
7D Reflective element
10 Control unit
91 Illumination optical system
5a, 5b Fly-eye lens
5c Polarization conversion element
5d Superimposed lens
Se, 5g Dichroic mirror
5f, 5l Field lens
5h, 5j Relay lens
5i, 5k, 5m Mirror
SR Sensor
SB Sensor
92R, 92G, 92B Optical modulation unit
93 Cross-dichroic prism
94 Projection lens
PJ Projector

What is claimed is:

1. A light source device comprising:
a first laser light source unit configured to emit first-color light having a first polarization direction;
a second laser light source unit configured to emit first-color light having a second polarization direction different from the first polarization direction;
a polarization separation element configured to separate the first-color light, which has the first polarization direction, emitted from the first laser light source unit and the first-color light, which has the second polarization direction, emitted from the second laser light source unit into a first light beam and a second light beam;
a wavelength conversion element configured to convert the first light beam separated by the polarization separation element into a third light beam;
an optical element configured to convert the second light beam separated by the polarization separation element into a fourth light beam; and
a control unit configured to adjust a first drive current value of the first laser light source unit and a second drive current value of the second laser light source unit,
wherein the polarization separation element is configured to synthesize the third light beam converted by the wavelength conversion element and the fourth light beam converted by the optical element, and
wherein the control unit is configured to adjust the first drive current value of the first laser light source unit and the second drive current value of the second laser light source unit, on the basis of a first measurement result and a second measurement result, wherein the first measurement result is acquired by a first sensor measuring a first light quantity of red light included in white light that is synthesized and emitted by the polarization separation element, and wherein the second measurement result is acquired by a second sensor measuring a second light quantity of blue light included in the white light.

2. The light source device according to claim 1,
wherein the control unit is configured to decrease the first drive current value of the first laser light source unit and to increase the second drive current value of the second laser light source unit, in case that an actual light quantity ratio that is a ratio between the first light quantity of the red light measured by the first sensor and the second light quantity of the blue light measured by the second sensor is higher than a target light quantity ratio; and
wherein the control unit is configured to increase the first drive current value of the first laser light source unit and to decrease the second drive current value of the second laser light source unit, in case that the actual light quantity ratio is lower than the target light quantity ratio.

3. The light source device according to claim 2, further comprising:
a third laser light source unit configured to emit the first-color light having the first polarization direction,
wherein the polarization separation element is configured to separate the first-color light, which has the first polarization direction, emitted from the first laser light source unit and emitted from the third laser light source unit, and the first-color light, which has the second polarization direction, emitted from the second laser light source unit, into the first light beam and the second light beam, and
wherein the control unit is configured to: decrease the first drive current value of the first laser light source unit and a third drive current value of the third laser light source unit and to increase the second drive current value of the second laser light source unit, in case that the actual light quantity ratio is higher than the target light quantity ratio; and
wherein the control unit is configured to: increase the first drive current value of the first laser light source unit and the third drive current value of the third laser light source unit, and to decrease the second drive current value of the second laser light source unit, in case that the actual light quantity ratio is lower than the target light quantity ratio.

4. The light source device according to claim 2, further comprising:
a third laser light source unit configured to emit the first-color light having the first polarization direction; and
a fourth laser light source unit configured to emit second-color light, which has the second polarization direction, different from the first-color light;
wherein the polarization separation element is configured to separate the first-color light, which has the first polarization direction, emitted from the first laser light source unit and the third laser light source unit, the first-color light, which has the second polarization direction, emitted from the second laser light source unit, and the second-color light, which has the second polarization direction, emitted from the fourth laser light source unit, into the first light beam and the second light beam, and
wherein the control unit is configured to: decrease the first drive current values of the first laser light source unit and the third drive current values of the third laser light source unit, and to increase the second drive current value of the second laser light source unit, in case that the actual light quantity ratio is higher than the target light quantity ratio; and
wherein the control unit is configured to: increase the first drive current value of the first laser light source unit and the third drive current value of the third laser light source unit, and to decrease the second drive current value of the second laser light source unit, in case that the actual light quantity ratio is lower than the target light quantity ratio.

5. A projector comprising:
a light source device;
an optical modulation unit configured to form an image by modulating emission light of the light source device; and
a projection lens configured to project the image formed by the optical modulation unit,
wherein the light source device comprises:
a first laser light source unit configured to emit first-color light having a first polarization direction;
a second laser light source unit configured to emit first-color light having a second polarization direction different from the first polarization direction;
a polarization separation element configured to separate the first-color light, which has the first polarization direction, emitted from the first laser light source unit and the first-color light, which has the second polarization direction, emitted from the second laser light source unit into a first light beam and a second light beam;
a wavelength conversion element configured to convert the first light beam separated by the polarization separation element into a third light beam;
an optical element configured to convert the second light beam separated by the polarization separation element into a fourth light beam; and
a control unit configured to adjust a first drive current value of the first laser light source unit and a second drive current value of the second laser light source unit,
wherein the polarization separation element is configured to synthesize the third light beam converted by the wavelength conversion element and the fourth light beam converted by the optical element, and
wherein the control unit is configured to adjust the first drive current value of the first laser light source unit and the second drive current value of the second laser light source unit, on the basis of a first measurement result and a second measurement result, wherein the first measurement result is acquired by a first sensor measuring a first light quantity of red light included in white light that is synthesized and emitted by the polarization separation element, and wherein the second measurement result is acquired by a second sensor measuring a second light quantity of blue light included in the white light.

6. The projector according to claim 5, further comprising:
an illumination optical system configured to separate the white light emitted from the light source device into the red light, green light, and the blue light,
wherein the optical modulation unit comprises:
a first optical modulation unit configured to form a red image;
a second optical modulation unit configured to form a green image; and
a third optical modulation unit configured to form a blue image,
wherein the illumination optical system comprises:
a first mirror disposed on a first optical path of the red light emitted to the first optical modulation unit;
a second mirror disposed on a second optical path of the blue light emitted to the third optical modulation unit;
the first sensor disposed on an extension line of the optical path of the red light incident on the first mirror; and
the second sensor disposed on an extension line of the optical path of the blue light incident on the second mirror,
wherein the first sensor is configured to measure a first light quantity of the red light transmitted through the first mirror without being reflected by the first mirror, and
wherein the second sensor is configured to measure a second light quantity of the blue light transmitted through the second mirror without being reflected by the second mirror.

7. The projector according to claim 5, wherein the illumination optical system, which is configured to separate the white light emitted from the light source device into the red light, the green light, and the blue light, further comprises:
a third sensor configured to measure a third light quantity of the green light included in the white light that is synthesized and emitted by the polarization separation element.

8. A control method for controlling a light source device that comprises:
a first laser light source unit configured to emit first-color light having a first polarization direction;
a second laser light source unit configured to emit first-color light having a second polarization direction different from the first polarization direction;
a polarization separation element configured to separate the first-color light, which has the first polarization direction, emitted from the first laser light source unit and the first-color light, which has the second polarization direction, emitted from the second laser light source unit into a first light beam and a second light beam;
a wavelength conversion element configured to convert the first light beam separated by the polarization separation element into a third light beam;
an optical element configured to convert the second light beam separated by the polarization separation element into a fourth light beam; and
wherein the polarization separation element is configured to synthesize the third light beam converted by the wavelength conversion element and the fourth light beam converted by the optical element,
wherein the control method comprises:
acquiring a first measurement result by a first sensor measuring a first light quantity of red light included in white light that is synthesized and emitted by the polarization separation element;
acquiring a second measurement result by a second sensor measuring a second light quantity of blue light included in the white light; and
adjusting the first drive current value of the first laser light source unit and the second drive current value of the second laser light source unit on the basis of the first measurement result acquired by the first sensor and the second measurement result acquired by the second sensor.
